(19) United States
(12) Patent Application Publication
(10) Pub. No.: US 2020/0337942 A1
(43) Pub. Date: Oct. 29, 2020

(54) Method for Treating Coronavirus Infection Using a Stimulating Device for Improvement of Respiratory Function

(71) Applicant: Satina Medical UG, Berlin (DE)

(72) Inventors: Zisi Fotev, Wandlitz (DE); Jörg Pötzch, Berlin (DE)

(21) Appl. No.: 16/867,952

(22) Filed: May 6, 2020

Related U.S. Application Data
(63) Continuation-in-part of application No. 16/301,576, filed on Nov. 14, 2018.

(51) Int. Cl. A61H 23/02

(52) U.S. Cl. CPC A61H 23/0254; A61H 2230/40; A61H 2205/084; A61H 2201/165; A61H 2201/1621; A61H 2201/5043; A61H 2201/0165; A61H 2205/083

(57) ABSTRACT

A method for treating a human patient with a coronavirus infection improves the respiratory function of the patient to resist the onset of pneumonia or other severe respiratory distress that would require mechanical ventilation, or to improve respiratory function after the patient is removed from a mechanical ventilator. The method includes the step of stimulating the diaphragm of the patient using a stimulating device. The method may be initiated prior to or after the patient exhibiting symptoms of respiratory distress, and/or may be initiated after the patient has been removed from a mechanical ventilator.

### RELATED APPLICATION

This application is a continuation-in-part of co-pending U.S. patent application Ser. No. 16/301,576 “Stimulating Device” filed Nov. 14, 2018 at Attorney Docket No. 7-4283, which in turn is a US nationalization of PCT Application No. PCT/EP2016/002196 filed Dec. 30, 2016, which in turn claims priority to expired U.S. Provisional Patent Application No. 62/336,952 filed May 15, 2016 and U.S. Design patent application No. 29/572,567 filed Jul. 28, 2016 which issued as US Design Patent D841,178 on Feb. 19, 2019, each priority application being incorporated by reference as if fully set forth herein.

### FIELD OF THE DISCLOSURE

The disclosure relates to methods for treating human beings having a coronavirus infection, and in particular, to methods for improving respiratory function of human beings having a coronavirus infection.

### BACKGROUND OF THE DISCLOSURE

Coronaviruses are a family of viruses that commonly infect the respiratory systems of human beings. The COVID-19 infection for example is caused by the novel severe acute respiratory syndrome coronavirus 2 (SARS-CoV-2) that appears to have originated in the area of Wuhan, China in 2019 and has spread worldwide as a global pandemic.

Patients suffering from a coronavirus infection, such as a COVID-19 infection as a non-limiting example, often present impaired respiratory function, including respiratory distress of the upper and lower respiratory systems. Symptoms include, but are not limited to, hyperventilation, shortness of breath, and/or low blood oxygen levels.

As a coronavirus infection progresses, a patient may develop pneumonia or other severe respiratory distress. The patient may then require intubation, inserting an endotracheal tube through the mouth and then into the airway. The patient is then placed on mechanical ventilation using a ventilator that “breathes”—inhales and exhales a breathing gas—for the patient. Ventilation may be required for two weeks or more.

Unfortunately the experience of mechanical ventilation with coronavirus patients provides increasing evidence that ventilators are a threat for patients.

The human thoracic diaphragm is a large, thin muscle located at the bottom of the lungs. In normal, unassisted breathing the diaphragm pulls down and expands the lungs. The lung expansion creates suction, or negative pressure, that draws air into the lungs. But ventilators force the breathing gas into the lungs under high, positive pressure to blow the lungs up like a balloon. A lung is not designed to function as a balloon, and forcing the gas at positive pressure into the lung further damages lung tissue.

The breathing gas also contributes to lung damage. The breathing gas contains oxygen, often at toxic concentrations, that causes additional lung damage.

A conscious patient cannot take intubation and ventilation. Multiple sedatives are needed to silence protective reflexes of the body against this severe intervention. Application of sedatives or anesthesia for longer than 24 hours has unwanted effects on the human body, including a paralyzing effect on the diaphragm.

Long-term mechanical ventilation patients may become invalids after the intubation tube is removed and the mechanical ventilation has ended. Some patients removed from a mechanical ventilator lose the ability to breathe independently on their own. Patients may suffer post-traumatic syndrome and many suffer from post-treatment depression.

Furthermore, mechanical ventilation is expensive. The cost of mechanical ventilation of one patient may be 20,000 Euros per day and a typical duration of 10 days results in a total charge of 200,000 Euros. Avoiding mechanical ventilation removes the financial burden of ventilation from both the treating facility and the patient, and enables access to a limited supply of mechanical ventilators by patients, where this procedure is unavoidable to prevent immediate death of the patient.

Thus there is a need for a method for treating human beings infected with a coronavirus, and in particular, a method for improving the respiratory function of human beings infected with a coronavirus to resist the onset of pneumonia or other severe respiratory distress that would require mechanical ventilation.

### SUMMARY OF THE DISCLOSURE

Disclosed is a method for treating human beings having a coronavirus infection, and in particular, a method for improving the respiratory function of patients having a coronavirus infection to resist the onset of pneumonia or other severe respiratory distress that would require mechanical ventilation.

Embodiments of the disclosed method for treating a human patient having a coronavirus infection utilize a stimulating device that stimulates respiratory function of the patient while allowing the patient to naturally, pleasantly, and relaxingly breathe and suck air deep into the lungs without use of positive pressure. The stimulating device trains the diaphragm and provides efficient and natural oxygen intake by the patient.

The stimulating device stimulates the patient's diaphragm and facilitates deep belly breathing that improves respiratory function. This results in the normalization of the breathing rate, gas exchange in the lungs becomes more efficient and oxygen in the blood increases significantly. For treatment of a coronavirus infection, the disclosed method can be used as an additional preventative measure used in conjunction with conventional coronavirus treatment to further hinder the progression of the coronavirus infection and resist the onset of pneumonia or other severe respiratory distress that would require mechanical ventilation.

Further, the disclosed method enables the patient to benefit from additional therapeutic benefits provided by the stimulating device, namely an increase in blood oxygen levels, lower heart and breathing rates, reduced anxiety, and improved sleep quality

An embodiment of the method for treating a human patient having a coronavirus infection includes the steps of providing an external stimulating device, fastening the stimulating device to the patient, and stimulating the patient's diaphragm by operating the fastened stimulating device to thereby improve the respiratory function of the patient.

An embodiment of a stimulating device usable for performing the method includes a belt containing at least two vibration modules and a control panel. Each vibration module includes a pod with a casing, a vibration pad arranged within the casing, and a vibration motor with a flywheel arranged within the casing. The vibration motor is mounted to the vibration pad via at least one elastic motor housing. The control panel operates the vibration motors of the vibration modules.

An embodiment of the method for treating a human patient having a coronavirus infection includes the steps of providing the stimulating device, fastening the belt of the stimulating device to the abdomen of the patient wherein the at least two vibration modules are externally applied to an abdominal region of the human, and stimulating the patient's diaphragm by operating the belt of the fastened stimulating device to thereby improve the respiratory function of the patient.

The disclosed method may be applied to a patient prior to the patient being diagnosed with and/or exhibiting symptoms of pneumonia or other severe respiratory distress that would indicate the need for mechanical ventilation.

The disclosed method may be used before or after the patient demonstrates symptoms of respiratory distress, including hyperventilation, shortness of breath, and low blood oxygen levels.

The disclosed method may also be used with patients that have been taken off a ventilator. Such patients may need to in effect re-learn breathing on their own, often enough without success. The available tools and methods to facilitate this process are unsatisfactory. The disclosed method helps re-activate the patient's natural physiological breathing mechanism and trains the patient's diaphragm and breathing reflex to actively support natural breathing again.

The disclosed method is equally suited to treat patients both in inpatient and outpatient settings, and while the patient is quarantined at a treatment facility or while staying at home.

The disclosed method may be used with a patient multiple times while the patient is infected with a coronavirus to encourage maintenance of satisfactory respiratory function throughout the term of the infection.

A stimulating device for use in the disclosed method may include: a belt containing at least two vibration modules, wherein each of the at least two vibration modules comprises: a pod with a casing and a vibration pad arranged within the casing, and a vibration motor with a flywheel within the housing, a control panel operating said vibration motors of the at least two vibration modules; wherein the vibration motors are mounted to the vibration pad via at least one elastic motor housing.

The disclosed method may include use of the stimulating device in treating patients with a coronavirus infection by fastening the belt to the abdomen of a patient and operating the belt, wherein the at least two vibration modules are externally applied to the abdominal region of the patient to stimulate the patient's thoracic diaphragm, to enhance respiratory function.

The elastic motor housing of the stimulating device may provide for elastic support of the vibration motor relative to the belt and housing of the motor such that generated vibrations are mainly directed to the patient and thus the energy impacting a patient is used more efficiently compared to the devices known from the state of the art. With the directed vibrations due to elastic mount/suspension the vibration pad vibrates and the impulse has more degrees of freedom and provides for a better impact on diaphragm. The device and the method of the present invention enhance respiratory function by stimulating the diaphragm.

The disclosed method alleviates the symptoms related to hyperventilation and shallow breathing arising from a patient's coronavirus infection and may avert pharmaceutical intervention or may be used in conjunction with pharmaceutical intervention to maintain, improve, or resist degradation of respiratory function. The method may result in increased blood oxygen levels, reduced heart and breathing rates and improved patient quality of life during the infection. The method is easy to use and generally results in efficient stimulation of the patient's diaphragm.

The disclosed method can stimulate the patient's diaphragm to enhance pulmonary function, and subsequently the parasympathetic nervous system to enhance relaxation, reduce the heart and breathing rates and improve sleep quality and even pain. For example, the method may be used for assisting the patient in falling asleep, where the number of revolutions of the motor is reduced. This can provide additional positive effects for the patient. The stimulating device may contain a belt with at least two removable engaged vibration modules, which are provided to make contact with the patient to engage the diaphragm of the patient.

Generally, embodiments of the disclosed method may apply a biomechanical vibration to the patient through the contact of the vibration modules via the pods and vibration pads with the patient's body. The belt may consist of at least two vibration modules, each housing a vibrating motor. The vibration modules are engaged with a strap, creating a belt, for contacting the abdomen of a patient to stimulate the diaphragm. The motors are controlled by an electronic circuit. The electronic circuit is controlled by a control panel, which may be powered by a battery that is optionally rechargeable. The control panel controls the voltage and time that the motors run for.

The belt may be worn by the patient any time during the day or night. The belt may be worn only for the amount of time that the patient or treating physician wishes for the diaphragm to be stimulated, or it may be worn for an extended period of time and the vibration motors activated intermittently throughout the extended period of time. The belt may be used in any position by a patient, for instance sitting, standing, or in a supine position. The vibrations “train” the patient's diaphragm so that the diaphragm's ability to function or contract on its own increases and after the use in the morning or evening should keep increased respiratory function for several hours. Minimum use time is generally about 10 min and up to 30-60 min. Moreover, the diaphragm recognizes the vibrations increasingly faster with repeated use that it commences to work quicker with each use of the belt.

The belt may include three vibrating modules that are arranged equidistant or in varying distance to allow for an optimal stimulation effect of the diaphragm for deep breathing movement of the stomach, i.e. the pods and vibration pads with the motors continue to vibrate optimally during the expansion phase of the lungs during inhalation.

Each of the vibration motors of the device may be spaced away from the vibration pad via the motor housing. This measure ensures a free movement of the flywheel attached to the motor within the housing or casing.

The motor housing may be mounted to the vibration pad via a snap-fit connection. This measure provides for a secure coupling of the motor and the motor housing. Alternatively, suitable attachment means may be used and or additional attachment means, e.g. adhesives or mechanical couplings.

Each of the motor housings may at least be partly designed in a complementary manner to the vibration motor for holding and supporting the vibration motor. This measure provides for an easy assembly of the device and a secure support of the motor within the motor housing.

The belt of the device may include a strap having at least one belt fastening attachment. The belt may be flexible. This measure provides for an easy adjustment of the belt to the patient, specifically to the abdomen of the patient. The belt fastening attachment may be of any suitable fastener or fastener arrangement (for example, hook and loop fasteners).

The casing may include a main casing and a back casing wherein the vibration pad is arranged within the back casing and/or the main casing is provided with a front panel. With this measure the vibrations are directed to a patient more efficiently. Specifically with an elastic vibration pad and the elastic motor housing the vibrations impacting on the casing are dampened and the vibration pad is supported resiliently with respect to the casing.

The main casing and/or the back casing of the device comprise may include a connection or an attachment for engagement with and through the strap and engagement with the other of the back casing or main casing. This measure provides for a suitable and safe connection between casing and strap and ensures that the vibration pads are kept in position.

The control panel may operate said vibration motors with an amplitude from around 0.3 G to 1.0 G and frequency ranging from 16 Hz to 45 Hz complementary to a voltage 0.6V to 1.3V. Preferably the control panel operates said vibration motors with an amplitude of around 0.4 G at a frequency of 30 Hz (0.8V) to an amplitude of 0.62 G at a frequency 37 Hz (1.0V). The exact optimal frequency and amplitude is also patient-dependent, i.e. weight, age and general sensitivity. With these operation conditions optimal effects are achieved and quantified as clear changes in breathing pattern to deep, slow rhythmic diaphragm breathing and quantified as reduction in breathing rate of 20% or more.

The belt may be flexible and/or adjustable to a patient's anatomy. Hence, the length of the belt can easily be adapted to different patients and one belt can be adapted to different patients.

The at least one of the flywheels may be dimensioned of around 12 mm diameter and 8 mm thickness. This measure provides for efficient vibrations.

The at least one of the flywheels may have a weight of 7-8 grams and/or is spaced 1-5 mm from the end of the motor. This measures may even more improve the efficiency of the device and the impact of the vibrating impulses. This weight and arrangement is based on several test results (compare below).

The device may further include a display for displaying and monitoring vital functions, wherein the display of vital functions is integrated via an interface and/or the interface supports the exchange of information with an external device. This measure can improve the functionality of the device.

The disclosed method for treating a patient with a coronavirus infection may include engaging a belt device to the abdomen of a patient, the belt device including: a) a strap having a belt fastening attachment; b.) at least two vibration motors engaged with said strap; c) said motor including a flywheel of 12 mm diameter, 8 mm thickness and 7-8 grams; d) a control panel operating said at least two vibration motors; wherein said vibration motors have amplitude from 0.3 G to 1.0 G and frequency ranging from 16 Hz to 45 Hz. In an embodiment the at least two vibration modules are externally applied to an abdominal region of a patient to stimulate the diaphragm, to enhance respiratory function.

The stimulating device may contain a belt, wherein the belt is adjustable in size to accommodate for variations in the size of a patient. The belt may contain at least two removable vibration modules, each module containing a vibration motor controlled by a control panel device. The belt may be provided to contact the abdominal region of a patient under the rib cage to stimulate the diaphragm.

The vibrating motor may be effective at varying voltage, amplitude and frequency. An approximate effective range of the amplitude is from about 0.3 G to about 1.0 G, or a voltage from about 0.6V to 1.3V. An approximate effective range of the frequency is from about 16 Hz to about 45 Hz.

The disclosed method may be used to deepen abdominal or flank breathing of a patient with a coronavirus infection. Abdominal breathing, also called diaphragmatic breathing, is a normal, easy breathing form. The diaphragm is the main breathing muscle and is located between the chest and the abdominal cavities. Abdominal breathing occurs by a contraction of the diaphragm, whereby the negative pressure in the pleural space is growing. Following this negative pressure, the lung extends and air gets sucked into the lung. Exhalation in this breathing technique occurs by relaxation of the diaphragm, whereby the lung due to its own elastic properties contracts and pushes the air out. Consciously, exhalation can also be supported by the patient contracting the abdominal muscles.

The disclosed method may be used for increasing the activity of the diaphragm of a patient with a coronavirus infection. With the contribution of mechanical vibrations, the muscle of the diaphragm gets stimulated and subsequently can contribute to a better expansion of the lungs.

A further benefit of the disclosed method is the possible activation of the patient's parasympathetic nervous system, which subsequently reduces heart and breathing rates, increases muscle relaxation, relieves tension, pain in lower torso, abdominal contractions and improves sleep quality. In addition, the method may help the patient sleep better or be used in weaning the patient from the use of mechanical ventilation.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 illustrates a front view of an adjustable belt, in a linear open position, having at least two vibration modules and associated control panel.

FIG. 2 illustrates an exploded view of a pod component of a vibration module.

FIG. 3 illustrates a view of a contact side of a belt having at least two vibration modules and associated control panel.

FIG. 4 illustrates a vibration motor.

FIG. 5 illustrates a front perspective view of the control panel.

FIG. 6 illustrates a back perspective view of the control panel.

FIG. 7 illustrates an exploded view of the control panel.

FIG. 8a illustrates a back perspective view of a vibration module.

FIG. 8b illustrates a sectional side view of the vibration module 12 of FIG. 8a.

FIG. 9 illustrates the disclosed method for treating a human patient with a coronavirus infection.

FIG. 10 is a chart of the lung capacity of patients after treatment in accordance with the disclosed method.

### DETAILED DESCRIPTION

While the present disclosure may be susceptible to embodiments in different forms, the drawings show, and herein will be described in detail, embodiments with the understanding that the present description is to be considered an exemplification of the principles of the disclosure and is not intended to be exhaustive or to limit the disclosure to the details of construction, the arrangements of the components, or the order of method steps set forth in the following description or illustrated in the drawings.

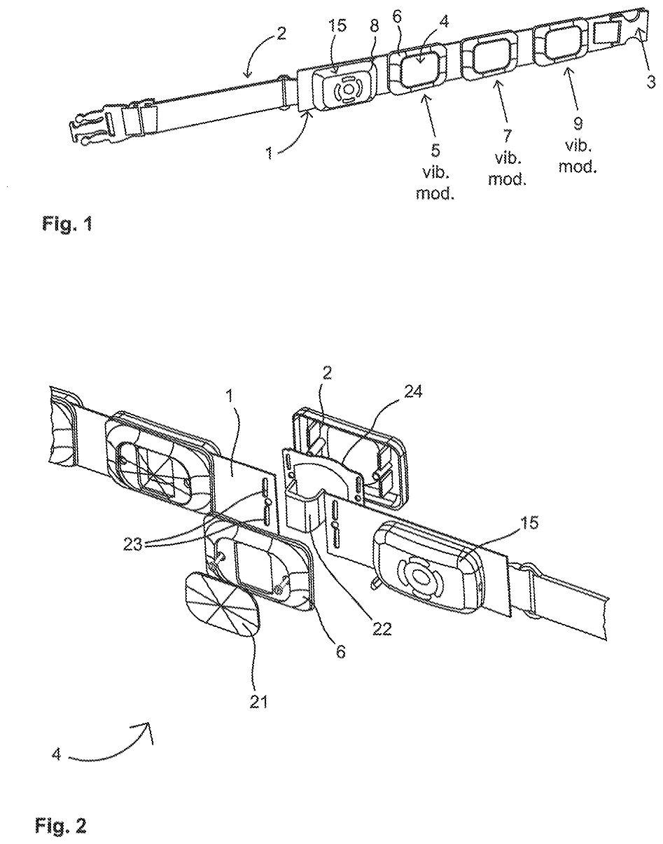

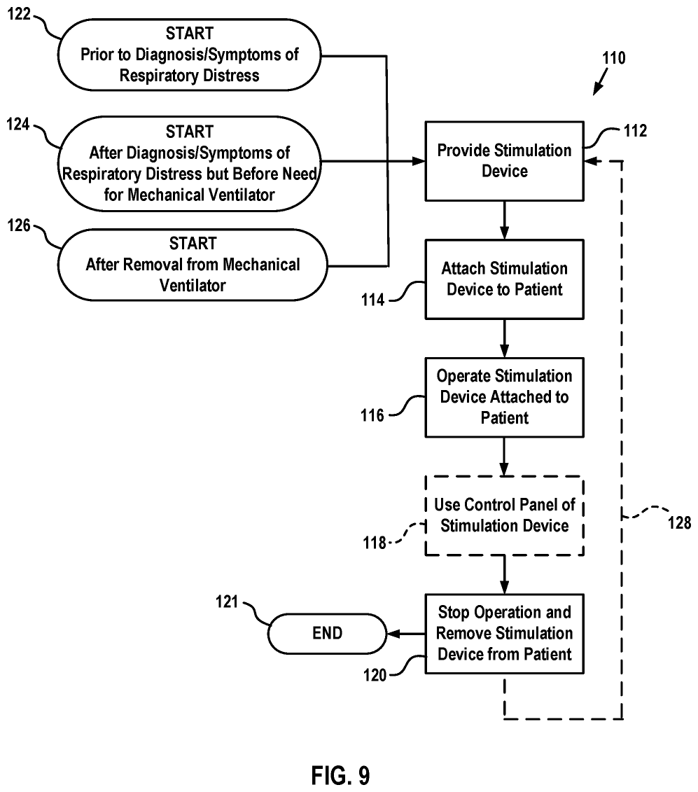

FIGS. 1-7, 8A, and 8B illustrate a stimulating device usable in the method for treating a human patient having a coronavirus infection illustrated in FIG. 9.

Generally, an embodiment of a stimulating device usable with the disclosed method applies a mechanical vibration to the patient's body through the contact of vibration pads of a respective pod comprising vibration motors. The device may consist of at least two vibration modules, each housing a vibrating motor. The vibration modules are engaged with a strap, creating a belt, for contacting the abdomen of a patient to stimulate the diaphragm. The motors are controlled by an electronic circuit. The electronic circuit is controlled by a control panel, which may be powered by a battery that is optionally rechargeable. The control panel controls the voltage and time that the motors run for. The belt may be worn by a patient any time during the day or night. The belt may be worn only for the amount of time that the patient or the patient's physician wishes for the diaphragm to be stimulated, or it may be worn for an extended period of time under a physician's care and the vibration motors activated intermittently throughout the extended period of time. The belt may be used in any position by a patient, for instance sitting, standing, or in a supine position.

FIG. 1 illustrates the front view of a length-adjustable belt 10 of an embodiment of a stimulating device usable for performing the disclosed method. The belt 10 is shown in an open position, with three vibration modules. More particularly, the belt 10 includes a first vibration module 5, a second vibration module 7 and a third vibration module 9. Each vibration module includes a casing 6 and a pod 4 containing a vibration motor. The belt 10, further depicts a strap 1 between the vibration modules 5, 7 and 9. Further, a control panel 15 is mounted to the strap 1 in any suitable manner, for example via clamp 8. The vibration modules 5, 7 and 9 are mounted to the strap 1 of the belt 10 equidistantly. When attached to a patient this arrangement allows for the optimal stimulation effect of the diaphragm for deep breathing movement of the stomach, i.e., the belt 10, i.e. vibration pads of the vibration modules 5, 7 and 9 (pods 4) with the motors continue to vibrate optimally during the expansion phase during inhalation.

The strap 1 of belt 10 may be constructed of a variety of suitable materials, including lycra, any material containing spandex, neoprene, elastic, cotton, nylon webbing, StretchBands™, silicone, ethylene propylene diene monomer (M-class) rubber, urethane, Chloroprene, Hypalon, natural rubber, leather, cloth, plastics and the like. In an embodiment, the strap 1 is stretchable and made of materials such as including lycra, any material containing spandex, neoprene, elastic, nylon webbing, StretchBands™, silicone, ethylene propylene diene monomer (M-class) rubber, urethane, Chloroprene, Hypalon or natural rubber. In yet another embodiment, strap 1 is made of a combination of neoprene, elastic and nylon webbing. Strap 1 may be of varying lengths and widths suitable for the size of the respective patient. Strap 1 may be constructed of an inner strap, closest to the abdomen of a patient, and an outer strap away from a patient. Between the inner strap and outer strap are paths of the wires leading from a control panel to the motors. Alternatively, the path of the wires may be integrated in the strap.

Belt 10 further includes a belt fastening attachment 2, 3 for closure around a patient. The belt fastening attachment 2, 3 may be selected from a variety of off the shelf buckles such as quick-release clips, simple buckles, adjuster buckles, belt buckles and the like. In other embodiments, the belt securing attachment 2, 3 may comprise snaps, clips, zippers, buttons, clasps, clips, knots, ties, Velcro, pins, hooks or any other fastening means known in the art.

Vibration modules 5, 7 and 9 each contain a removable pod 4, which contains a vibration motor. Pod 4 is advantageously removable for repair or exchange of the pod or vibration motor. In an embodiment, the motor sits in a plastic housing that clicks into place, and the outer casing of the removable pod(s) 4 is screwed over the complete casing 6. The pod can also be glued to casing 6. Said pod 4 may be made by injection molding of materials such as plastic, metal, silicone, synthetic fabric and the like. The dimension of the pod may vary. Smaller pods may be used for smaller belts and larger pods may be used for larger belts. In an embodiment, the pods may be about 6-8 cm in width; about 8-9 cm in Length; and about 2.5-3.5 cm in depth depending on the size of the motor to be housed.

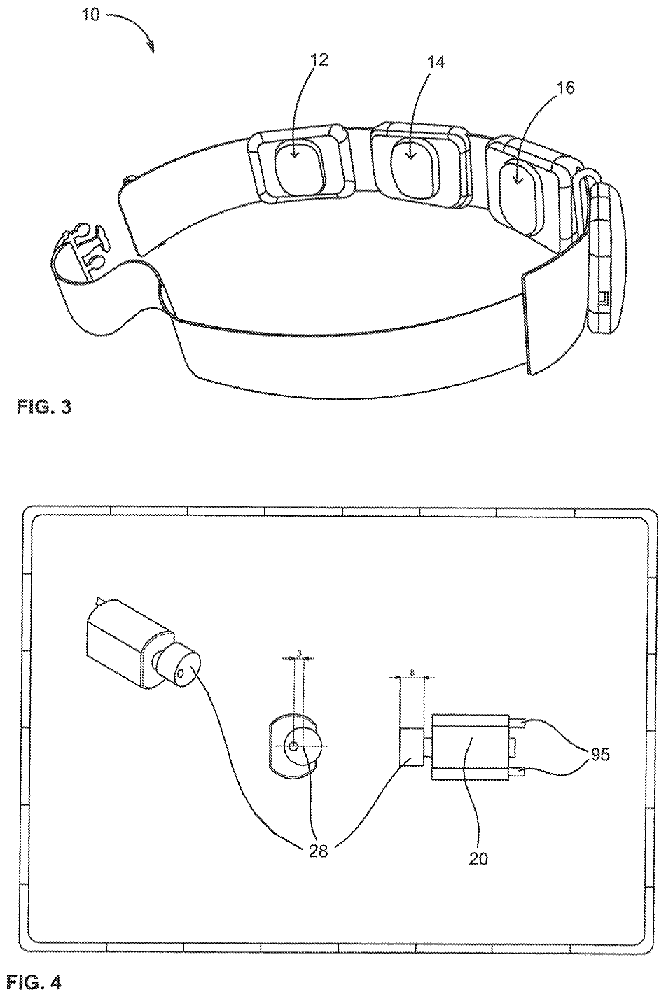

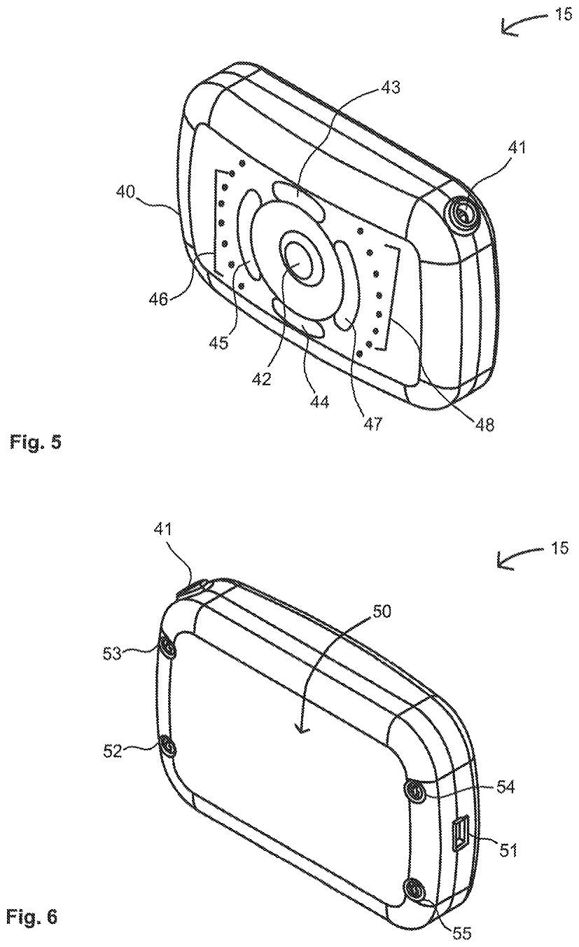

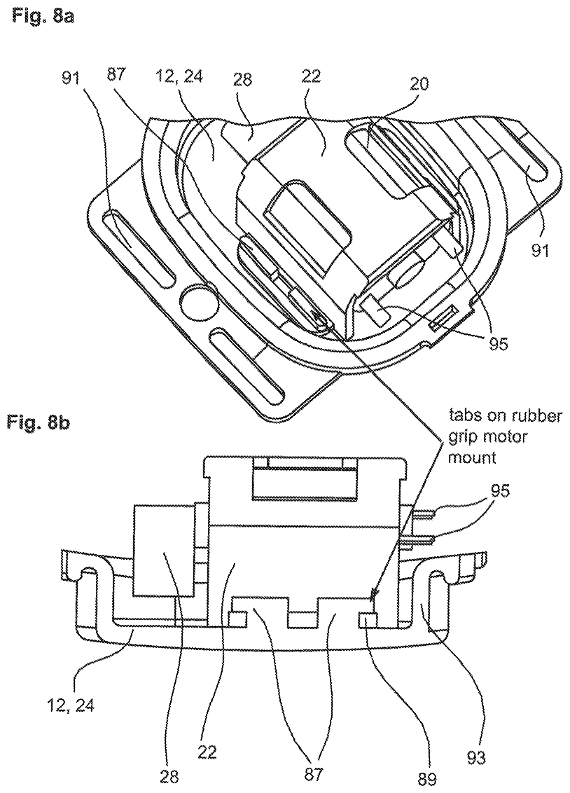

Relating to FIG. 2, the exploded view of pod 4 illustrates a front panel 21, which covers the pod. The front panel 21 may be made of ABS plastic and made by injection molding. The front panel 21 may be made of any metal or other suitable material. The front panel 21 may be of any color and may be imprinted or embossed with a logo or design. The casing 6 forms a structural cabinet feature that clamps the strap into position and guides the wiring. The belt has slits 23 for engaging the casing 6 to secure to the belt. The casing 6, may also be made by injection molding of ABS plastic. The casing 6 may also be made of metal or any other suitable material. The pod 4 also comprises a back casing 26 with a motor housing 22. The motor housing 22 receives and houses a vibration motor 20 and is mounted to a vibration pad 24. The motor housing 22 isolates the motor from main casing 6. In an embodiment, the motor housing 22 may be made of ABS plastic by injection molding, or may be made of any other suitable material. In an embodiment each of the motor housings 22 is made of an elastic material, e.g. silicone. The motor housings 22 are designed at least partly complementary to the outer surface of the motor 20 (comp. FIGS. 4 and 8a, b) to receive and hold the motor 20 when the pod 4 is mounted or assembled. The vibration pad 24 is used to transmit the vibrations from the motor to the patient's body. The vibration pad 24 incorporates damping features, such as a sponge, and isolates the vibration motor from main casing 6. The vibration pad may be made of a silicone, i.e. Rubber, TPE/TPU or PVC or any other suitable material. The back casing 26 forms a structural cabinet to clamp the strap in position via slits 23 of strap 1 and to guide wires. For this purpose the back casing 26 comprises two extensions that extend perpendicularly to the back casing 26 for engagement with slits 23 of strap 1. The casing 6 comprises pins or other suitable means also extending perpendicularly to the casing 6 for counter engagement with the extensions to hold the vibration modules 5, 7 or 9 or pod 4 securely on the strap 1 in position. The back casing 26 may be made by injection molding of ABS plastic, or may be made of metal or any other suitable material.

FIG. 3 illustrates the posterior side of the casing 6 and a contact side of the pod 4, whereby contact is made by vibration pads 12, 14 and 16 (24 in FIG. 2). The vibration pads 12, 14 and 16 (24) provide beneficial features, such as transmitting the vibration effects in a more focused and efficient manner than plastic casing due to the elastic support or mount of the motor 20 within the elastic motor housing 22. The elastic support of the motor 20 with respect to the casing 6 and back casing 26 allows for directing most of the generated vibrations to the patient, increasing the efficiency of the stimulating device. The silicone vibration pad is also quieter than plastic casing construction and more comfortable for the patient.

Vibration motors may be off the shelf and equivalent to Precision Microdrives™, Model 320-100, Uni-Vibe™, 20 mm Vibration Motor—25 mm Type. A variety of motors may be used, as generally illustrated in FIG. 4. The vibration motor may generally include motor casing, washers, a NdFeB neodymium permanent magnet, a motor shaft, a motor end cap, ball race bearings and an eccentric mass counter weight (the flywheel 28). Larger or smaller motors may be used in various device embodiments, but what is critical is that the frequency or amplitude or voltage range is achieved with any type of motor for the effect to be seen. It has been noted that larger motors may cause discomfort, pain or abrasions. However, variations in performance were noted when similar motors were tested with variations of size and weight of the flywheel. The flywheel should be spaced 1-5 mm from the end of the motor in a preferred embodiment.

Surprising results were seen related to a small change in the flywheel size/dimension and weight, which had a significant effect on stimulating the diaphragm in an effective manner. In addition, an optimal range of the frequency-amplitude was determined, outside of which effectiveness in stimulating the diaphragm significantly decreases. Therefore, the frequency-amplitude relationship is very critical to cause activation of the diaphragm. Activation of the diaphragm can be measured as a change in breathing pattern, i.e., shallow breathing versus slower deep belly breathing. This can be quantified by slower breathing (rate/min) and also heart rate.

The flywheel was of 12 mm diameter, 8 mm thickness and 7-8 g. The motor is Precision Microdrives™, Model 320-100.

### Table:

Effects on diaphragm quantified as below:

+++ is strong activation of deep belly (diaphragm) breathing; the breathing rate is deeper and slower as measured by breaths per minute (reduction greater than 20% of normal previous breathing)

+ is only slight effect on diaphragm breathing i.e., a 10% or less reduction of breathing rate
No effect on diaphragm activation or breathing rate

| Voltage | Amplitude | | Frequency | Effect on diaphragm |
|---|---|---|---|---|
| 1.2 V | 0.95 | G | 43 Hz | +++ |
| 1.0 V | 0.62 | G | 37 Hz | +++ |
| 0.8 V | 0.4 | G | 30 Hz | +++ |

Precision Microdrives™, Model 2 (320-105 standard). This has exactly the same motor as above, but different flywheel (18 mm diameter×6 mm thickness, but is only a half circle, i.e., not complete).

| Voltage | Amplitude | Frequency | Effect |
|---|---|---|---|
| 1.2 V | 1.0 G | 45 Hz | − |
| 1.0 V | 0.8 G | 35 Hz | + |
| 0.8 V | 0.5 G | 28 Hz | + |

Model 3. Same motor but flywheel slightly different (10 mm diameter, 3.5 mm thickness)

| Voltage | Amplitude | | Frequency | Effect |
|---|---|---|---|---|
| 1.2 V | 0.8 | G | 55 Hz | − |
| 1.0 V | 0.54 | G | 45 Hz | − |
| 0.8 V | 0 34 | G | 37 Hz | − |

Effects on respiratory function were notable within the range from 0.3 G at 20 Hz to 1.00 at 45 Hz. Optimal effects were observed in the range from 0.8V (30 Hz at 0.4 G) to 1.0V (37 Hz at 0.62 G). Optimal effects are quantified as clear changes in breathing pattern to deep, slow rhythmic diaphragm breathing and quantified as reduction in breathing rate of 20% or more. The amplitude was measured using a closed-loop control (accelerometer) and accurate motor speed measurement device. An NEVA 7361 triple axis accelerometer from Freescale was used and mounted on a PCB with several external components. The vibration motor and accelerometer were mounted together. These were then mounted with a 100 g mass (sled). This target mass has a direct influence on the measured vibration amplitude and helps to standardize the measurements. This was done as described by Precision Microdrives of UK.

The device may include a single control panel PCBA, which includes a number of TACT switches and LED's. The control panel may be used to control the speed of the motors by varying the voltage supplied to the motors. The control panel may also control the time the motors run for and have pre-programmed functions that control the time for different motor speeds. FIG. 1 additionally, illustrates a control panel 15, removably engaged with strap 1, for convenient storage via clamp 8. Control panel 15 is a handheld device, which can work independently from the power grid using a grid-independent power supply, such as a battery. Generally, the control panel 15 may be made of any suitable plastic or metal known in the art. Control panel 15 may be fixedly or removably secured to strap 1 by any means known in the art.

FIG. 5 illustrates a front perspective of the control panel 15, having a front control panel casing 40. Also illustrated, a wire port 41 connects a circuit board in the control panel 15 to the motors. Power control pad 42 turns the control panel 15 on or off. Program 1 control pad 43 is to select a pre-programmed schedule of voltage and time by which the vibrating motors will operate. Examples of such programs are provided below. Program 2 control pad 44 is to select an alternate pre-programmed schedule of voltage and time by which the vibrating motors will operate. Examples of such programs are provided below. A timing control pad 45 may provide a step-wise increase of the time the vibrating motor will operate. A timing button may be programmed to increase or decrease in any increment of time, such as seconds, minutes, hours and the like each time it is selected. Timing Magnitude Indicators 46 is a light feature to indicate the increase or decrease in increments of time. Speed control pad 47 is selected to increment Voltage each time it is selected. The increment in Voltage may either be an increase or decrease, the magnitude of which is indicated by the lighting on Speed Magnitude Indicators 48. Varying control features may be incorporated into a control panel for the present invention. LED readouts of which program is selected, the speed, timing and any other useful information for a patient may be provided. Additional control buttons may be added, which may be specific to each motor, for instance to turn the power on an off for each motor independent of the others. Other controls and selection buttons may be added for independent control of the speed, voltage, amplitude, frequency and time of operation of each motor independent of the others. Those skilled in the art will recognize that a variety of controls may be incorporated in the control panel to enhance user experience for convenience and/or maximum health benefit. The buttons of the present invention may be made of any suitable material known in the art, and may include silicone and rubber.

FIG. 6 illustrates a back perspective view of control panel 15, providing a back control panel casing 50 and view of charging port 51 for recharging a rechargeable battery in the control panel 15. FIG. 6 illustrates charging port 51 as a micro USB port, however any suitable charger and port used in the art may be used. FIG. 6 also indicates four screws 52, 53, 54, 55 by which the control panel is secured from the front panel to a back panel 56.

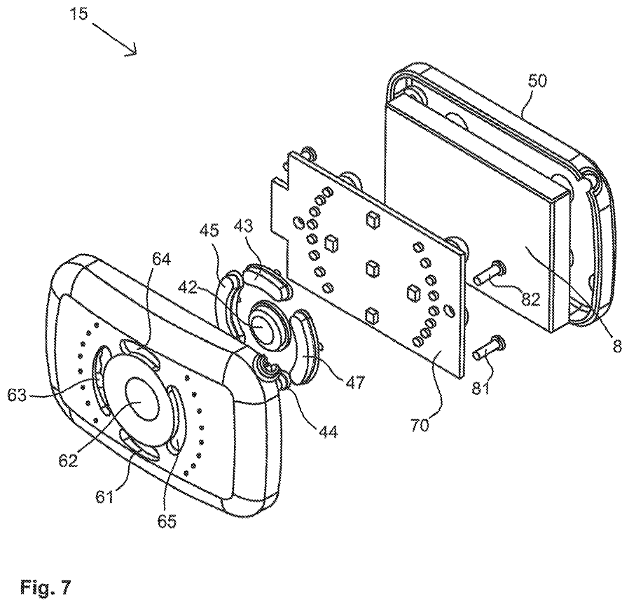

FIG. 7 is an exploded view of control panel 15, having front control panel casing 40 comprising perforations 61, 62, 63, 64, 65 for receiving control pads 42, 43, 44, 45, 47 (not fully shown). Control pads 42, 43, 44, 45, 47 engage with and operate an electrical circuit board 70. Circuit board 70 is programmed with multiple programs to control the voltage, amplitude, frequency and times for which the vibrating motors will engage. Examples of such programs are below. The back of the circuit board 70, not depicted, comprises wire connections for the electrical circuit to route through the wire port 41 to the positive and negative inputs of the vibrating motors. Pegs 81, 82 are used to mount the front control panel casing 40 to the back control panel casing 50. FIG. 7 also depicts a rechargeable battery 85, encased and enclosed within the control panel 15 by the back control panel casing 50. Rechargeable battery 85 may be any of those used in the industry, including but not limited to lithium sulfur, sodium ion, thin film lithium, zinc bromide, zinc cerium, vanadium redox, sodium-sulfur, molten salt, silver-zinc, Quantum Battery or any other suitable rechargeable battery.

The control panel may be programmed with different variations in voltage and time to provide a patient or treating physician with varied options depending on need. Programs may start the rotating motors for any length of time, but the best results have been seen with at least 10 minutes of use. Motors may be programmed to pulsate or provide intermittent stimulation of the diaphragm, of varying duration, throughout the day for a patient that wears the device throughout the day or night. Examples of programs selectable on the control panel are as follows:

Program 1

| Voltage | Time (min) |
|---|---|
| 1.0 V | 10 |
| 0.9 | 10 |
| 0.8 | 10 |

Program 2

| Voltage | Time (min) |
|---|---|
| 1.0 V | 5 |
| 0.9 | 10 |
| 0.8 | 15 |

Program 3

| Voltage | Time (min) |
|---|---|
| 1.2 V | 2 |
| 1.0 | 10 |
| 0.9 | 10 |
| 0.8 | 10 |

Program 4

| Voltage | Time (min) |
|---|---|
| 1.2 V | 5 |
| 1.0 | 5 |
| 0.9 | 10 |
| 0.8 | 10 |

Program 5

| Voltage | Time (min) |
|---|---|
| 0.8 | 10 |
| 0.7 | 10 |
| 0.6 | 10 |
| 0.7 | 5 |
| 0.8 | 5 |

Program 6

| Voltage | Time (min) |
|---|---|
| 0.9 | 10 |
| 0.8 | 10 |
| 0.7 | 10 |
| 0.6 | 10 |
| 0.8 | 5 |

Program 7

| Voltage | Time (min) |
|---|---|
| 1.0 | 10 |
| None | 5 |
| 1.0 | 10 |
| None | 5 |
| 0.8 | 10 |
| This cycle | |
| repeats for 1 | |
| hr | |

Program 8 - For Sleep Apnea Patients

| Voltage | Time (min) |
|---|---|
| 1.0-1.2 | 10 |
| 0.9 V | 5 |
| 0.8 V | 5 |
| Off | 10 |
| 0.8 | 10-20 |
| | seconds |
| | every 2-5 |
| | minutes |
| This cycle | |
| repeats for | |
| 2-3 hours | |

Clinical results indicating the effectiveness and health benefit of the disclosed stimulating device were obtained for patients having respiratory deficiencies. In one trial, 68 COPD grade patients were tested. These patients used the stimulating device three times per day, for 20 minutes, and for 10 days. The results were as follows:

1. 62 patients reduced their breathing rate from 18 to 14 breaths/minute.
2. 62 patients improved their blood p02 from an average 92% to 97%.
3. 58 patients described their breathing as more comfortable.

18 patients received treatment with the stimulating device for 2 weeks. Of those patients, 14 could walk without shortness of breath and 11 could reduce their medication needs after the 2 week course of treatment.

A small study with 3 patients suffering from sleep apnea was able to show that when the patients stopped breathing, activation of the disclosed stimulating device only for a few seconds caused the patients to immediately start breathing. The sleep apnea patients could subsequently continue to sleep without any disruption.

In geriatric patients treated with the disclosed stimulating device, muscle relaxation in regions of the legs, belly region and chest were clearly observed, as well as a more relaxed and slow breathing rhythm. This enabled the patients to feel better and allow physical movement

Obese patients with a coronavirus infection may also benefit from the disclosed method since they may have a limited lung volume due to greater adipose tissue around the lungs, which reduces the bronchioles, limits lung capacity and increases the breathing rate, leading to less oxygen intake.

In addition, patients with a coronavirus infection and also suffering insomnia may also benefit from the disclosed method to have significantly longer and better quality sleep to better resist progression of the infection.

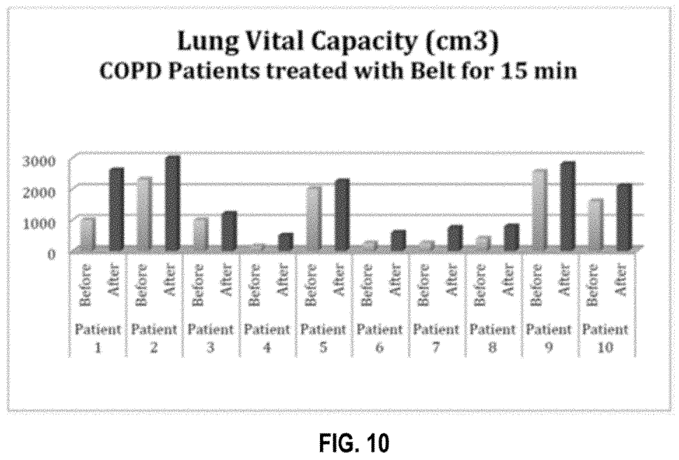

In yet another study, ten patients with COPD were treated with the disclosed stimulating device for fifteen minutes. After a single use of the belt, the lung volume of all ten patients significantly increased as indicated in the chart shown in FIG. 10.

Another patient who used the disclosed stimulating device belt, a self-reported strong smoker, had consistent coughing and wheezing prior to using the device. The patient reported a cessation of coughing and wheezing for three days after a single use of the device for 15 minutes.

The disclosed stimulating device may also be used for monitoring specific vital functions of a patient with a coronavirus infection. A display of vital functions can be integrated via an appropriate interface. An embodiment of the stimulating device has at least one interface that supports the exchange of information. The information can be present in the form of physical units (e.g., as electrical voltage, current strength) or logical variables (data), whereas the exchange can be analog or digital. The interface includes data interfaces (interfaces for data transmission in general), general interfaces, machine interfaces (interfaces between physical systems), hardware interfaces (interfaces between physical systems of computer technology), network interfaces (interfaces between network components), software interfaces (interfaces between programs) and/or user interfaces (interfaces between man and machine). Preferred interfaces include radio or infrared interface or wired interfaces (for example USB). Using the interface, a secure and fast connection can be established and information exchanged. In addition, the device may be connected to other devices for monitoring vital functions, allowing a check of the safe and efficient operation of the device. It may also be preferred that the information (e.g. data) is saved on a storage medium or is transmitted from a computer based system—a transmitter—to the recipient via a network-based transmission or a long distance data transmission. The transmission medium is preferably the telephone network, radio or light, whereby a rapid and secure transfer of information is possible. Advantageously, the device itself has a memory that can store the data, such as duration of use and rotation speed selected. The device may transfer the data to an external storage medium. The data can be advantageously used for the analysis of the application, thereby allowing optimization of the application.

FIG. 8a illustrates a perspective back view of a vibration pad 12 (14, 16) without main casing 6 and back casing 26, and FIG. 8b illustrates a sectional side view of the vibration pad 12 of FIG. 8a. The vibration pad incorporates damping features, such as a sponge, and isolates the vibration motor from main casing 6. The vibration pad 12 is designed to house the motor 20 and includes a rectangular outer surrounding with rounded edges that is designed like a trough. On both sides of the vibration pad 12/24 flat side extensions are provided for mounting the vibration pad 12/24 to the strap 1 and the casing 6 as well as back casing 26 (compare FIG. 2). For this purpose the extensions each include two slits 91 and a hole (partly shown in FIG. 8a) that are designed complementary to the extensions of the back casing 26 as well as the mounting means of the main casing 6 for secure engagement when the vibration module 5, 7, 9 is assembled.

On the inner surface of the trough of the vibration pad 12/24 two tabs 87 are provided on both sides that extend approximately in parallel to one of the slits 91. The tabs 87 are provided for secure engagement of the motor housing 22 with the vibration pad 12/24. For this engagement the motor housing 22 includes on both its lower end sides slits complementary to the tabs 87 for a snap fit connection when passing the tabs 87. Further, in some embodiments also suitable adhesives, e.g. silicone glue may be added on the mounting area to improve this connection. The motor housing 22 is further designed in a “u”-like shape, complementary to motor 20 for receiving and holding the motor 20. When the motor 20 is mounted via the motor housing 22 to the vibration pad 12/24 it is kept at a distance to the inner surface of the vibration pad 12/24 such that the flywheel 28 can move within the casing 6 and back casing 26 freely without any contact to the casing 6 and back casing 26 (compare FIG. 8b). Further, the motor 20 comprises two connectors 95 extending from the end of the motor 20 opposite to the flywheel 28 for electrical connection with the control panel 15 via wires (not shown). The vibration pad 12 provides beneficial features, such as transmitting the vibration effects in a more focused and efficient manner than plastic casing due to the elastic support or mount of the motor 20 within the elastic motor housing 22. The elastic support of the motor 20 and flywheel 28 with respect to the casing 6 and back casing 26 allows for directing most of the generated vibrations to the patient thereby increasing the efficiency of the stimulating device.

FIG. 9 illustrates the disclosed method 110 for treating a human patient with a coronavirus infection. The coronavirus infection may be caused by the SARS-CoV-2 coronavirus or some other coronavirus.

In a step 112, a stimulating device is provided. The stimulating device is configured to be usable in stimulating the thoracic diaphragm of the patient. The stimulating device may be a stimulating device as described above and as shown in FIGS. 1-7, 8a, and 8b.

In a step 114, the stimulating device is attached to the patient. The stimulating device may configured to stimulate the diaphragm when attached over or on a particular part of the patient's body, for example, the abdomen.

In a step 116, the stimulating device is operated while fastened to the patient's body to stimulate the patient's diaphragm. The patient uses his/her diaphragm to expand the lungs and create suction drawing air into the lungs. The stimulating device stimulates the diaphragm as described above.

In an optional step 118, the stimulating device may include and be controlled through a control panel. The control panel may enable the patient, the administrating physician, or facility personnel to set or adjust operation of the stimulating device as described above. The control panel may also display or transmit data concerning the vital functions of the patient, start time, end time, and elapsed time in use, and the like.

In the step 120, the stimulating device is turned off and removed from the patient. The duration of treatment may be according to a preset schedule or preset operating mode of the stimulating device, or may be determined by feedback from the patient, the vital signs of the patient or by some other criterion to end the method at the end box 121.

As represented in the start boxes 122, 124, 126, the method 110 may first be initiated at different points in the course of the patient's infection.

In the start box 122, the method is initiated prior to any diagnosis and/or symptoms of respiratory distress. The method may be initiated as a precautionary measure to improve respiratory function as early as possible in the course of the infection to minimize the risk of mechanical ventilation as much as possible.

In the start box 124, the method is initiated after a diagnosis and/or presentation of systems of respiratory distress, but before the need for a mechanical ventilator. Symptoms of respiratory distress may include, but are not limited to, hyperventilation, shortness of breath, and/or low blood oxygen levels.

In the start box 126, the method is initiated after removal of the patient from a mechanical ventilator. The patient may require weaning from the mechanical ventilator to unassisted breathing, or it may be felt that improved respiratory function would improve the patient's outcome after mechanical ventilation.

The method may be initiated and utilized multiple times during the course of the patient's infection as indicated by the dashed line 128 to maintain respiratory function or to improve respiratory function. The supervising physician may choose to change the frequency, duration, and other parameters of the method in view of the patient's response to the method and to changes in the patient's other medical conditions, pharmaceuticals, and the like during the course of the infection.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including (but not limited to) changes in material selection, size, operating ranges, environment of use, as well as such changes and alterations that fall within the purview of the following claims.

What is claimed is:

1. A method for treating a human patient infected with a coronavirus infection, the patient having a thoracic diaphragm, the method comprising the steps of:
(a) providing a stimulating device being operable to stimulate a human thoracic diaphragm when fastened to the patient;
(b) fastening the stimulating device to the patient; and
(c) operating the stimulating device when fastened to the patient and while the patient is breathing, the patient's diaphragm expanding the patient's lungs to draw air into the lungs while the patient is breathing,
whereby operation of the stimulating device stimulates the diaphragm during the patient's breathing.

2. The method of claim 1 wherein the stimulating device is configured to stimulate the diaphragm when attached to an abdomen of a human being and step (b) comprises the step of fastening the stimulating device to the patient's abdomen.

3. The method of claim 1 including the steps of:
(d) removing the stimulating device from the patient; and
(e) repeating steps (a)-(d) multiple times during the course of the patient's infection.

4. The method of claim 1 wherein, immediately before initiating the method, the patient has not been diagnosed with and/or does not exhibit symptoms of pneumonia or other severe respiratory distress that calls for mechanical ventilation of the patient.

5. The method of claim 4 wherein the patient has not been diagnosed with and/or does not exhibit symptoms of hyperventilation, shortness of breath, and/or low blood oxygen levels immediately before initiating the method.

6. The method of claim 1 wherein the patient was on a mechanical ventilator during the course of the infection and has been removed from the mechanical ventilator prior to initiating the method.

7. The method of claim 1 wherein the stimulating device comprises a belt containing at least two vibration modules and a control panel, wherein each of the at least two vibration modules comprises a pod with a casing, the casing enclosing a vibration pad, a vibration motor with a flywheel, and at least one motor housing mounting the vibration motor to the vibration pad, and the control panel operating said vibration motors of the at least two vibration modules.

8. The method of claim 7 wherein step (b) comprises the step of:
fastening the belt of the stimulating device to the abdomen of the patient.

9. The method of step 8 wherein, immediately before initiating the method, the patient has not been diagnosed with and/or does not exhibit symptoms of pneumonia or other severe respiratory distress that calls for mechanical ventilation of the patient.

10. The method of claim 8 wherein the patient has not been diagnosed with and/or does not exhibit symptoms of hyperventilation, shortness of breath, and/or low blood oxygen levels immediately before initiating the method.

11. The method of claim 8 wherein the patient was on a mechanical ventilator during the course of the infection and has been removed from the mechanical ventilator prior to initiating the method.

12. The method of claim 8 repeated multiple times during the course of the patient's infection.

13. The method of claim 7 wherein for each pod of the stimulating device, the vibration motor is spaced away from the vibration pad via the motor housing.

14. The method of claim 7 wherein for each pod of the stimulating device, the motor housing is mounted to the vibration pad via a snap-fit connection.

15. The method of claim 7 wherein for each pod of the stimulating device, each motor housing is at least partly designed in a complementary manner to the vibration motor for holding and supporting the vibration motor.

16. The method of claim 7 wherein the belt of the stimulating device comprises a strap having at least one belt fastening attachment.

17. The method of claim 7 wherein for each pod of the stimulating device, the casing comprises a main casing and a back casing, the vibration pad in the casing being arranged within the back casing and the main casing being arranged with a front panel.

18. The method of claim 17 wherein the belt of the stimulating device comprises a strap having at least one belt fastening attachment; and
wherein the main casing and/or the back casing of each pod of the stimulating device comprises at least one attachment means for engagement with and through the strap and engagement with the other of the back casing or the main casing.

19. The method of claim 7 wherein the control panel of the stimulating device operates said vibration motors with an amplitude from around 0.3 G to 1.0 G and frequency ranging from 16 Hz to 45 Hz complementary to a voltage 0.6V to 1.3V.

20. The method of claim 19 wherein the control panel of the stimulating device operates said vibration motors with an amplitude around 0.3 G at a frequency of 20 Hz (0.8V) to an amplitude 0.62 G at a frequency 37 Hz (1.0V).

21. The method of claim 7 wherein the belt of the stimulating device is flexible and/or adjustable to a patient's anatomy.

22. The method of claim 7 wherein at least one of the flywheels of the stimulating device has a diameter of about 12 millimeters and a thickness of about 8 millimeters.

23. The method of claim 7 wherein at least one of the flywheels of the stimulating device has a weight of between 7 grams and 8 grams and/or is spaced about between 1 millimeter and 5 millimeters from the motor.

24. The method of claim 7 wherein the stimulating device comprises a display being configured to display the vital signs of the patient, the method comprising the steps of monitoring the vital signs of the patient, and displaying the vital signs of the patient on the display of the stimulating device.

25. The method of claim 1 wherein the patient is infected with the SARS-CoV-2 coronavirus.
